(19) United States
(12) Patent Application Publication
(10) Pub. No.: US 2023/0170647 A1
(43) Pub. Date: Jun. 1, 2023

(54) ELECTRICAL COUPLING

(71) Applicants: Siemens Energy AS, Oslo (NO); Siemens Energy Limited, Newcastle Upon Tyne (GB)

(72) Inventors: Andrew Robert Eastoe, Urangsvag (NO); Jonathan Hardisty, Ulverston (GB)

(73) Assignees: Siemens Energy AS, Oslo (NO); Siemens Energy Limited, Newcastle Upon Tyne (GB)

(21) Appl. No.: 17/920,715

(22) PCT Filed: May 26, 2021
(86) PCT No.: PCT/EP2021/063973

§ 371 Date: Oct. 21, 2022

(30) Foreign Application Priority Data
May 26, 2020 (GB) 2007828.3

(51) Int. Cl. H01R 13/523; H01R 13/52; H01R 13/621; H01R 43/00; H01F 38/14

(52) U.S. Cl. CPC H01R 13/523; H01R 13/5202; H01R 13/621; H01R 43/005; H01F 38/14

(57) ABSTRACT

A dry mateable subsea electrical connector coupling, having a removable connector body adapted to couple a first connector part, terminated to a subsea cable or jumper, to a subsea sensor device, or to a subsea wet mateable connector part. The removable connector body is adapted to seal a chamber of the first connector part terminated to the subsea hose or jumper and to receive electrical conductors of the subsea sensor device or subsea wet mateable connector part. The removable connector body includes electrical conductors and fittings adapted to receive corresponding electrical conductors and fittings from the hose or jumper.

This invention relates to an electrical coupling for a subsea device, in particular for coupling a subsea sensor or penetrator to a jumper, for subsea, or underwater, equipment and an associated method.

Subsea sensors and penetrators are typically hard wired to an oil filled jumper via a standard adaptor, known as a MK II. If the device needs to be dis-connectable, e.g., to allow easier installation of the subsea device, for repair or maintenance of the dis-connectable part, this requires the device to be connected via a subsea wet-mateable connector. As there is no standard design for subsea connectors, then the device can only be connected to the connector via an additional connector-specific adaptor, which adds cost and bulk. An improved device is desired.

In accordance with a first aspect of the present invention, a dry mateable subsea electrical connector coupling comprises a removable connector body adapted to couple a first connector part, terminated to a subsea cable or jumper, to a second connector part comprising a subsea sensor device, or to a subsea wet mateable connector part; wherein the removable connector body is adapted to seal a chamber of the first connector part terminated to the subsea hose or jumper and is adapted to receive electrical conductors of the subsea sensor device or the wet mateable connector part; and wherein the removable connector body comprises electrical conductors and fittings adapted to receive corresponding electrical conductors and fittings from the hose or jumper.

The coupling enables topside assembly of a sensor to a subsea cable or jumper to be carried out more easily than with current dry mate solutions and avoids the need for wet mate connectors on the back of the sensor, which is considerably more complex and costly to manufacture.

The electrical conductors and fittings of the removable connector body may comprise female electrical conductors and fittings and the corresponding electrical conductors and fittings comprise cables from the hose or jumper.

The removable connector body may comprise one or more inductively couplable electrical conductors and the corresponding electrical conductors and fittings comprise one or more inductively couplable electrical conductors from the hose or jumper.

In accordance with a second aspect of the present invention, a termination for a subsea cable or jumper comprises a first connector part; and a dry mateable subsea electrical connector coupling according to the first aspect; wherein the first connector part comprises a housing; seals to seal the coupling to the housing; and a release mechanism to releasably hold the removable connector body in place in the housing.

In accordance with a third aspect of the present invention, a subsea connector for a subsea cable or jumper, the connector comprising a first connector part according to the second aspect and a second connector part; wherein the second connector part comprises a housing; a connector body sealed to the housing; and electrical conductors; wherein the electrical conductors of the second connector part are adapted to electrically connect with the electrical conductors of the first connector part.

The electrical conductors of one of the first and second connector part may comprise inductively couplable conductors.

Alternatively, the electrical conductors of the second connector part may comprise male conductor pins and the electrical conductors of the first connector part comprise female electrical conductors corresponding to the male conductor pins.

The female electrical conductors may comprise conductors of the removable connector body; and wherein the second connector part comprises a wet-mate connector part.

The seals may comprise O-ring seals.

The release mechanism may comprise a circlip.

The chamber may further comprise a fluid inlet and closure member.

The fluid inlet and closure member allow the chamber to be pressure balanced once assembled.

The fittings may further comprise boot seals to seal the cable conductors from fluid in the chamber.

The fluid may comprise oil, in particular silicon oil.

The first connector part may comprise a first subsea housing portion including a first inductive coupling part; adapted to receive a second inductive coupling part of a subsea hose or jumper.

The fittings may comprise swage or crimp fittings.

In accordance with a fifth aspect of the present invention, a method of assembling a subsea connector part comprises feeding cables of a cable or jumper into a housing, terminating the cables to terminations of a removable connector body of the housing; sealing the removable connector body to the housing at one end of a chamber in the housing; sealing the cable or jumper to the housing at the other end of the chamber; filling the chamber with a pressure balancing fluid through a fluid inlet and closing the fluid inlet.

In accordance with a sixth aspect of the present invention, a method of assembling a subsea connector comprises feeding conductors of a subsea cable, or cables of a jumper into a housing, terminating the cable to terminations of a removable connector body; sealing the removable connector body to the housing at one end of a chamber in the housing; sealing the cable or jumper to the housing at the other end of the chamber; filling the chamber with a pressure balancing fluid through a fluid inlet and closing the fluid inlet.

The subsea connector may comprise a plug connector part and a receptacle connector part; wherein the method further comprises removing the removable connector body from the receptacle connector part; and terminating the cables directly to termination fittings of the plug connector part.

In one example, the connector of the subsea sensor device is a dry mateable connector part and the connection is made topside by inserting a plug into the receptacle and inserting fixings into openings in the housing and the plug to fix the two parts together. Alternatively, the method further comprises deploying the connector part subsea and electrically connecting a subsea device to the connector part with a wet-mateable connector part having male conductor pins corresponding to female conductor pins in the removable connector body of the connector part, by bringing the connector parts and their conductors into contact.

The method may comprise disconnecting the cables from the termination fittings of the removable connector body of the housing, removing the removable connector body, connecting the cables to male conductor pins of a dry mateable plug connector part inserted into the receptacle housing and sealing the plug and receptacle parts.

The removable connector body makes it possible to swap between a dis-connectable coupling and a permanent coupling without any other changes to the structure of the connector parts.

An example of a subsea electrical coupling and associated method of assembly in accordance with the present invention will now be described with reference to the accompanying drawings in which:

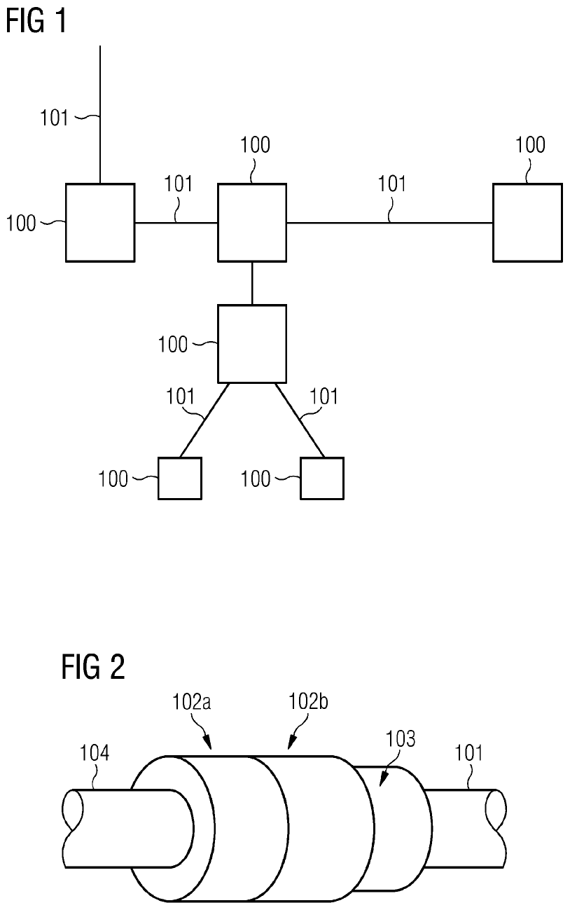

FIG. 1 illustrates a typical subsea system in which the coupling of the present invention may be used;

FIG. 2 illustrates a conventional connection of a hose and connector, using an adaptor;

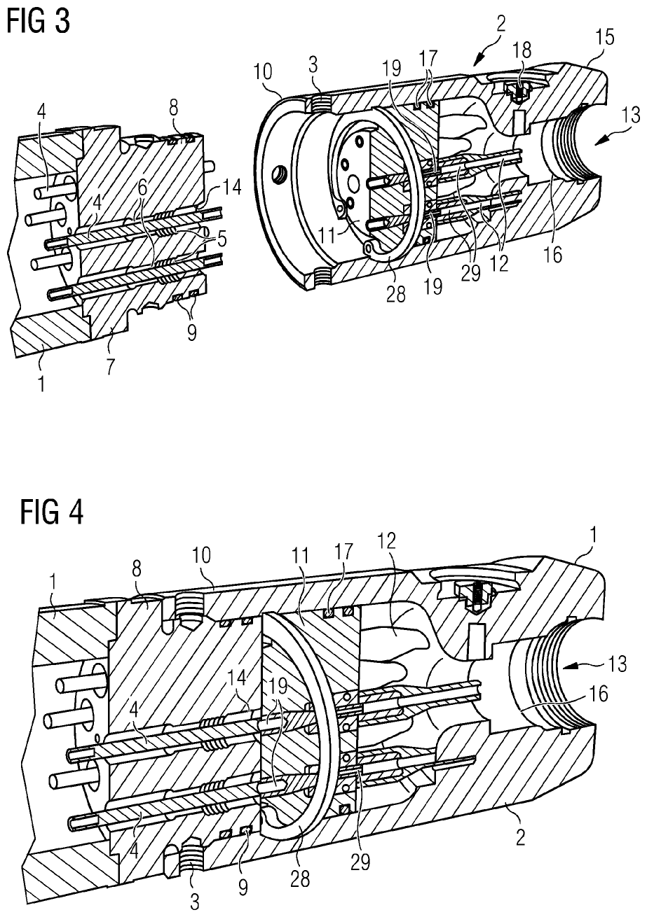

FIG. 3 is a sectional view illustrating parts of a connector arrangement according to the invention before the connection has been made;

FIG. 4 is a sectional view illustrating the parts of FIG. 1 after the connection has been made;

FIG. 5 shows an external view of the parts of FIG. 4 or 5;

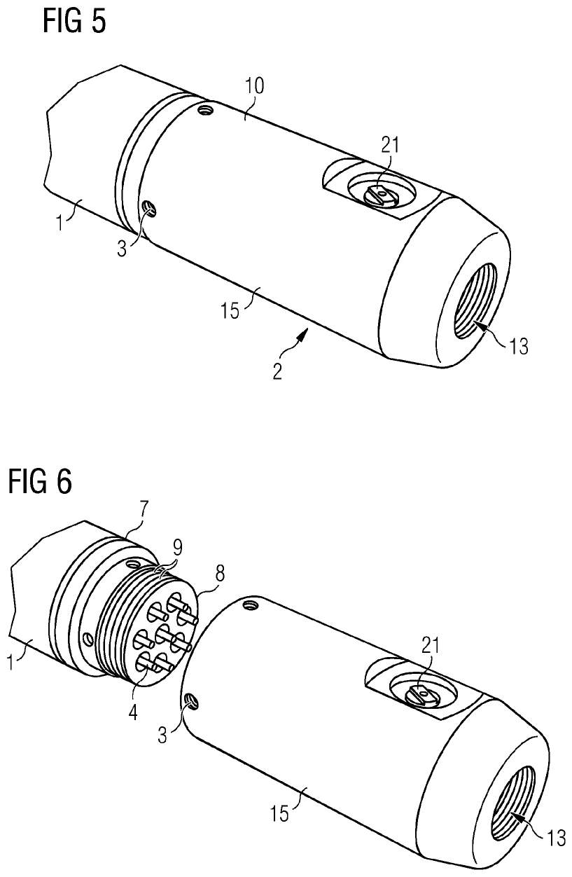

FIG. 6 is a perspective view of the parts of FIG. 1;

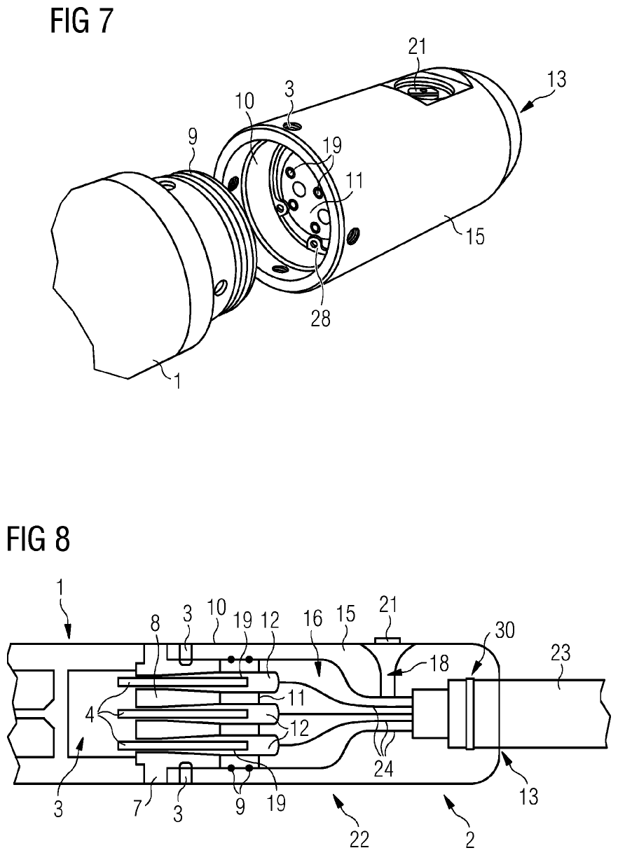

FIG. 7 is an alternative view of FIG. 4 or 5;

FIG. 8 is an alternative embodiment illustrating an integral dry mate connector on a hose or jumper;

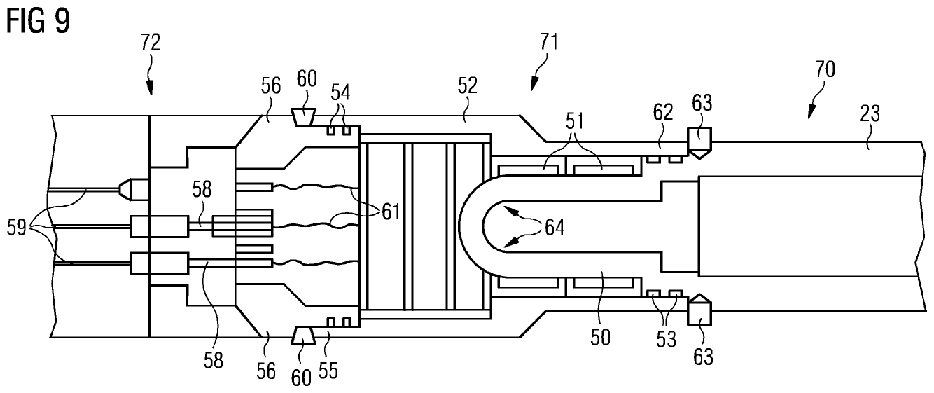

FIG. 9 illustrates an alternative embodiment according to the present invention, using inductive coupling; and,

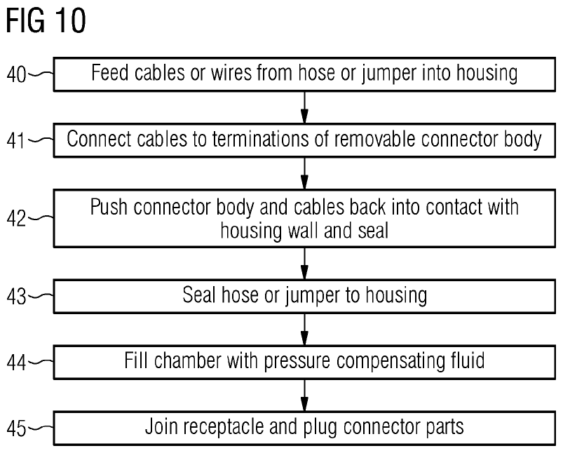

FIG. 10 is a flow diagram of a method of assembling a hose or jumper termination according to an aspect of the invention.

In a subsea electrical system, subsea connectors, or subsea equipment, such as sensors, junction boxes, transformers, pumps etc., may be connected together either by subsea jumpers, comprising hose and cable and oil, or by suitable subsea, seawater resistant, cables alone. The subsea cable or jumper provides electrical transfer of voltage and amps between two interfaces, in the form of connectors. Conventionally, the interface between the connector and the hose or cable is a permanent connection in the form of a cable gland, which is assembled or terminated in a factory, or at a suitable onsite customer facility by skilled technicians. Hence, the interface is limited by the requirements of a suitable clean environment, i.e., a factory or similar; by the need for a specialist technician, especially when the termination is done other than at a factory. The termination needs to be tested with the connectors or equipment attached, so in the course of the manufacturing process, the interface can only be assembled once the connectors or other equipment are available.

For example, the cable gland, through which electrical signals are routed from subsea devices to other subsea equipment, may comprise an adapter called a MK-II, or a standard swaged fitting, both of which are permanent connections. If there is a need to be able to disconnect the equipment from the jumper, then a connector must be used instead. The adaptor takes a different form according to variations caused by there being different suppliers of the connector, which may, for example, mean differences in size and sealing interface design. The specific adapter is mounted to the subsea device or equipment, in order to accommodate that particular subsea connector. This adds bulk, cost and complexity to the construction and fitting process.

FIG. 1 illustrates a typical subsea system in which subsea equipment 100, such as sensors, junction boxes, transformers, pumps, drives etc., may be connected by jumpers or cables 101. For example, power may be supplied via the cables or jumpers to transformers and switchgear through which the power is fed to loads, for example pumps, or separators, either directly, or through variable speed drives, according to the type of load. For example, data from pressure and temperature sensors in the well flow may be supplied via cables or jumpers to subsea control systems that use these input parameters to control the integrity of the well.

FIG. 2 illustrates a conventional arrangement in which a hose 101 is connected to a two part connector 102a, 102b via an adaptor 103, in order to make the hose connection to a cable 104 from the subsea equipment 100 dis-connectable, rather than a permanent, factory fitted, connection.

FIG. 3 illustrates an example of a feedthrough connector comprising two connector parts 1, 2. The example of FIG. 3 shows a feedthrough plug connector part 1 with male pins 4 which feed through openings 6 in a connector body 7, 8 and are sealed to the walls of the opening by seals 5 to prevent ingress of seawater. The connector body comprises a first section 7 having substantially the same diameter as the housing and a second section 10 having a reduced diameter to enable that part of the connector body to fit into the housing of the other connector part 2. The pins 4 protrude beyond face 14 of the connector body 8, so that they can electrically connect with corresponding female conductors of a coupling 11 in the form of a removable body 11 of a termination connector part. The connector part 2 comprises a housing 15 to receive cables of a hose or jumper (as can be seen in more detail in the example of FIG. 5) through an opening 13 into which a cable gland of the hose or jumper can be fitted to seal to that end of the housing 15. The removable connector body 11 is sealed, for example by O-ring seals 17, to the other end of the housing, thereby forming a chamber 16. The chamber may further comprise a fluid inlet 18, which has a closure, so that the chamber may be sealed off after fluid has been added, or as described in more detail below, the fluid filing may be done through the hose.

In this example, the removable connector body 11 is provided with through holes and female electrical conductors 19 lining those through holes. These conductors 19 extend into boot seals 12, providing physical protection of terminations 29 for the cables of the hose or jumper when connected, for example by crimping. The boot seals protect against, for example seawater ingress through the seal between the cable gland and opening 13. The removable body 11 fits part way into the housing 15, leaving a section 10 of the housing into which the narrower diameter section 8 of the other connector body to fit in. That section 8 then seals to the inner diameter of the housing by means of seals 9, for example O-ring seals.

The removable body 11 of the termination part 2 may be removed from the housing 15, by removing a releasable fastener 28, if a disconnectable connection is not required. In that case, the electrical conductors 4 of connector part 1 may then be connected directly to the fittings 29, for example by soldering or crimping. This is carried out topside, i.e., a dry mate connection. At the other end of the electrical conductors, not shown in the figures, this connector part 1 is either connected to a sensor device or a wet-mate connector part. With a sensor, the data from the sensors would be fed back via the cable or hose when deployed. With a wet mate connector part, the dry mated hose, coupling and wet mateable connector part are deployed subsea as a single assembly and another cable or jumper with a corresponding wet mate connector part may subsequently be wet-mated to the assembly.

For a dis-connectable connector, the connector parts 1, 2 are connected through the removable connector body 11, which receives the male pins 4 and has suitable sealing of those pins to the female pins 19, along with the pressure balancing of the fluid in chamber 16 to prevent sea water from entering the chamber and contacting the cable ends in the terminations 29, 12. The removable connector body 11, makes it possible to swap between permanent and dis-connectable coupling of the cables in the hose or jumper to other subsea equipment according to the customer requirement, simply by releasing the release mechanism 28 and taking out that removable body 11 when it is not required, but without any alteration of the construction of the rest of the connector parts 1, 2. Swapping what the cable or hose is connected to e.g. from a sensor to a wet mate connector part is done topside, but does not require the same level of skill as the normal dry mate termination, so can be done by the operator on site, rather than in factory conditions. Thus, connector parts 1, 2 and removable body 11 may be manufactured in the same way without needing to know in advance whether the connector parts are for a releasable connection of the hose or jumper, or for a fixed connection, or if releasable, the part that is actually going to be connected.

The fittings 29 of the connector part 2 receive wires or other electrical conductors through the cable gland in opening 13, for example in cables from an oil filled hose. The opening 13 is typically closed by a cable gland or equivalent on the hose or jumper with a corresponding threaded to that of the opening 13. For a fixed connection, the electrical conductors of the cables in the fittings 29 receive the pins 4 of the plug connector part directly and those pins make the electrical connection when the first and second connector parts 1, 2 come into contact there. However, if there is a need for the connector parts 1, 2 to be disconnected at some later stage, an additional, removable, connector part, in the form of the body 11 comprising female pins 19 is slotted into the housing 15 of the termination connector part 2 and the female conductors are electrically connected, for example by crimping or soldering, to the electrical conductors in the cable fittings, or terminations 29. The releasable fastener 28 may, for example, be a circlip, locking screws, or a threaded section with threaded ring collar. Whether connected directly or indirectly, the housing of the two connector parts 1, 2 has the same external diameter after connection and the same overall length, because the male pins are coupled to the cable ends at the same end point, but either through the additional connector part, which has the seals and pressure balancing needed for a connection of the plug part 1, or directly. Once connected, the housing of connector part 2 is fixed to the connector body 8, for example, by pins, or grub screws, through openings 3 in the housing 10.

As illustrated here, a first connector part 1 is a plug with male pins 4 which feed through the connector body 11 to connect with the cable ends and a second connector part, which receives electrical connections from a cable, or jumper, is a receptacle with female electrical contacts to receive the pins of the first connector part, when the parts are connected, as illustrated in FIG. 4. However, the invention may also be applied to the reverse arrangement in which the electrical connections from the cable or jumper are fed into a plug connector part with male pins and those male pins then connect to a receptacle connector part with female electrical contacts.

FIG. 4 illustrates the two connector parts 1, 2 when the connection has been made. These connector parts 1, 2 are joined via the additional removable connector body 11. When the connection has been made the body 11 is flush up against the body 8, which provides mechanical support for the body 11, so increasing its pressure holding capability. Thus, connector body 8 is not always holding the full pressure. The release mechanism 28 holds the body 11 in place and the seals 17, 9 of each body 11, 8 seal against the inner surface of the housing of the termination connector part 2. Fixed oil filled hose termination is achieved by using the coupling 11 and housing 15 as a containment shell for both the oil and the electrical wires. The electrical wires are run through the coupling and terminated, normally by soldering to the device feedthrough connection. Integrity of the solder connections may be maintained by a PEEK sleeve and rubber bootseal. The grub screws, or pins, may be inserted through the openings 3 in the end part 10 of the housing 15 which does not form part of the chamber 16. FIG. 5 illustrates the view of the closed connection from outside the housing, showing a closure 21 for the fluid filler 18. Oil may be filled through the filler 18, and air evacuated from the coupling and connecting hose assembly, using the fill screw 21 located on the housing 15. Alternatively, there is no filler or closure in the housing 15, but the fluid filling is carried out through the hose which is connected through the opening 13 of the housing. In this case, the fluid enters through the far end of the hose, either gravity fed, or using a vacuum and any air pushed out of the housing escapes through an opening or vent hole in a similar housing at the far end of the hose.

FIG. 6 is a perspective view showing the plug pins 4 protruding from the body 8, with seals 9 around to seal to the inner surface of the housing 15, when connected, as well as the wider diameter section 7 of the plug body. FIG. 7 is a perspective view also showing the removable body 11, with the female conductors 19 running through it and release mechanism 28 to hold the body 11 in place in the housing 15. The internal connector body 11 may be constructed from PEEK material or similar and contain female electrical connections 19 orientated in the same pattern as the device feedthrough connection male pins 4. Installation of the adapter housing to the subsea device engages the connector to the subsea device feedthrough connection and electrical contact may be made via a friction push fit type connection. After connection, the seals 9 of the plug part 1 seal against the inner surface of housing section 10 and fixings through holes 3 hold the two connector parts 1, 2 together.

FIG. 8 illustrates how the coupling of the present invention may be used to provide a subsea device with an electrical output connection which can be either fixed, permanently connected, or dis-connectable without changing the physical dimensions or using additional adapters in a dry mate. Outline 22 indicates the extent of a dry-mate connector part in the form of a penetrator 2 on the hose or jumper side comprising cable gland 30 sealing jumper or hose 23 in opening 13 of this connector part 2, with electrical conductors 24 from cables in the hose or jumper connected to fittings 29 on removable connector body 11. The fittings may include a boot seal to protect the termination of the penetrator pins, as well as an electrically insulating/partially conducting sleeve, for example a PEEK sleeve. The termination of the penetrator pins 19 on the cable side of body 11 is by conventional methods, such as by soldered or crimped connection. An end stop 26 may be mounted on the inner diameter of the housing 15 at an appropriate location, so that the removable body 11 sits in the correct part of the housing 15 and forms a closed chamber 16 between the body and the cable gland 30, with seals 9 sealing against the inner diameter surface of the housing 15. The penetrator, comprising body 11, pins 19, seals 9 and terminations 29, provides a pressure barrier from oil pressure when an oil filled hose is used and seals against water ingress when used as a cable termination to which a wet mateable connector part (not shown) on the connector part 1 may be connected. The penetrator provides a barrier towards the connector side and the cavity 16 may be filled with either an electrically insulating fluid, such as oil, or an electrically insulating gas, such as Nitrogen. The housing forming the dry mate part extends 10 beyond the removable body 11 and over the area in which body 8 of the connector 1 is inserted and seals (outside the dry mate part). The penetrator body 11 provides electrical pins 19 to allow the communication of voltage and amps through the penetrator from the cable 23 to the connector pins 4. The electrical conductors or penetrator pins 19 in the dry mate section are connected to the plug pins 4 by sliding fit with a low friction contact. The penetrator may be introduced into the cable gland and form part of the jumper part of the assembly. The penetrator is designed to be capable of sealing hydrostatic differential pressure of around 100 bar and crush pressure resistance of about 450 bar.

FIG. 9 illustrates an alternative embodiment of the invention, in which an inductive penetrator is used. Inductive penetrators may, for example, be of the type described in patent publication nos. EP3511519, WO2019141457, WO2019141432, or EP3511517, incorporated herein by reference. This embodiment comprises three elements, a hose and inductive penetrator element 70, a first connector element 71 and a second connector element 72. In the penetrator element 70, the hose 23 is mounted on a first inductive penetrator housing 50. Signals from conductors of cables (not shown) within the hose or jumper 23 may be inductively coupled across the wall formed by the housing 50, for example by means of coils 51. The first connector element 71 comprises a connector housing 52, an extension 62 of which includes locations for seals 53 and an opening for a release mechanism to hold the inductive penetrator housing of the hose or in contact with the connector. The seals 53 may be O-ring seals and the release mechanism 63 may, for example, be a locking screw, or grub screw. Removal of the release mechanism allows the hose element 70 to be disconnected from the connector element 71.

At the other end of the connector element 71, the housing 52 is shaped 55 to allow a body 56 to be fitted. Seals 54 seal the outer surface of the body 56 to the inner surface of the housing 55 at that point. Cables 61 pass signals that have been inductively coupled across the wall 50 to feedthrough conductors 58 of the second connector element 72 connected to cables 59. Fixings 60, such as grub screws hold the housing 55 and body 56 together. The arrangement shown has the advantage that the hose and inductive penetrator element 70 can be assembled in a factory, then shipped to a customer site where the connection to connector part 71 is relatively straightforward and not subject to needing ultra clean conditions, or skilled technicians. The two connector parts 71, 72 having previously been connected together.

The examples described above are for connection to a jumper, i.e., a hose containing cables and oil within it. In the case of a subsea cable alone, although the material of the cable is chosen to be seawater resistant, the cable lacks the pressure compensation provided within the hose or jumper by the oil, so a separate compensation component, typically a diaphragm, is required in the coupler at the point where the cable enters to compensate to the same pressure as the ambient subsea pressure. The method of connecting or terminating the conductors of the subsea cable in each example, is otherwise substantially similar.

FIG. 10 is a flow diagram of a method of assembling a feedthrough connection according to the present invention and a hose or jumper. Cables of a hose or jumper are fed 40 into a housing and terminated 41 to termination fittings of a removable connector body of the housing. Having completed the termination of the cables, the connector body is brought 42 into contact with end stops fixed to an inner diameter surface of the housing and the connector body 11 forms a seal with an inner wall surface of the housing 15. A cable gland or other sealing device of the hose or jumper is tightened to seal 43 the hose to another part of the housing, thereby forming a chamber within the housing between the connector body and the cable gland. The chamber may then be filled 44 with a pressure balancing fluid through a fluid inlet. In this process, air in the chamber 16 is removed through that inlet. The chamber is then closed by and closing the fluid inlet closure 21. The penetrator connector part is then ready to receive 45 the plug connector part from the subsea equipment. This may either be done topside before deployment, for a fully dry mate solution, or subsea, when the connector part 1 is a wet mate connector plug part. In that case, after deploying the connector subsea, the subsea device is electrically connected to the cables of the jumper or hose when the male conductor pins of the wet-mateable connector come into contact with the corresponding female conductors in the coupling connector body 11.

This jumper and penetrator combination have a number of advantages. They can be manufactured and assembled independently of the connector build, so that the assembly and test schedule may be decoupled, providing greater flexibility for customer and manufacturing requirements. The parts may be manufactured at different times in the delivery schedule and inspected and tested independently of the connector manufacture/assembly. Testing includes electrical and pressure tests, as well as visual inspection. Handling and storage is simplified because the connection of the connector, even for a dry mate connection, may be done late in the process, or the hose, or jumper and penetrator combination may even be delivered to a customer/third party independently of the connectors or other equipment. This makes lifting, manipulating, or transport easier because there are fewer parts, so less bulk and weight. At the point at which the connector from the subsea equipment is joined to the drymate penetrator and hose, or jumper, combination, this does not need the same skilled technician that carries out the factory manufacturing processes. The parts are simply pushed together and the fixing screws fitted into the openings 3 to hold the parts 1, 2 together. This has the benefits of increased availability, lower schedule risk and hence lower costs and simplifies on site removal and replacement if faults occur.

By removing the need for specific adapters for each jumper and connector combination that might be requested, it is possible to pre-build and test standard jumper, reducing delivery times. The coupling allows a full drymate solution to be provided if there is no need to subsequently disconnect the equipment and jumper or hose subsea, i.e., without any wet mateable connectors, or with the same parts on the hose side, a wet-mateable connector may be provided from the equipment if there may be a need to disconnect after deployment subsea.

The dis-connectable oil filled hose coupling offers a solution to achieve both fixed and dis-connect ability by using the same housing for both options, thus avoiding any dimension changes or the need for alternative adapters. When dis-connect ability the same adapter housing is used with an additional internal connector piece, which is easily retrofitted into the adapter housing. The standard adapter housing 15 contains the required internal features to accept the connector piece whether it is needed or not. The internal connector piece may comprise dual external O-rings on its outer edge to provide a seal against the oil within the harness assembly and the external environment.

The present invention provides various embodiments of a subsea connector with an electrical output connection which can be either fixed, i.e., permanently connected, or dis-connectable, without changing physical dimensions or using additional adapters. The electrical connection may comprise a removable internal connector part or body with female pins, which may be fitted in place between the cable end in the cable gland, or where a fixed connection is otherwise located in cable fittings and a feedthrough connector part with male pins that connects to the female pins. If the removable internal connector part is not used, then the male pins may be connected directly to the cable ends in the fittings, or terminations. For a fixed connection, the connector body may be used as a coupling, so that the cables from the hose, or jumper, are fed through the back of the connector part and connected to the fittings on the connector body, which are adapted to receive the male pins of the other connector part. If this form of coupling is not required, then the connector body in contact with the fittings may be removed and rather than the male pins connecting into the female pins of the coupling, with the female pins of that body connecting to the cable ends in the fitting, the male pins are connected directly to the cable ends.

Having a single solution for both fixed and dis-connectable connectors, reduces costs, as additional adapters are not needed and the removable connector body inside the connector housing is relatively inexpensive to produce. The coupling and connectors may be purchased in bulk and assembled locally as required, so there is no need to wait for suppliers to deliver as and when the subsea connectors are needed. This leads to flexibility for the customer to change their specification and choose dis-connectability late in the project schedule. As there is no need for an adapter and a full wet-mate connector, the overall weight and size is reduced, which helps when mounting to a subsea device.

It should be noted that the term “comprising” does not exclude other elements or steps and “a” or “an” does not exclude a plurality. Elements described in association with different embodiments may be combined. It should also be noted that reference signs in the claims should not be construed as limiting the scope of the claims. Although the invention is illustrated and described in detail by the preferred embodiments, the invention is not limited by the examples disclosed, and other variations can be derived therefrom by a person skilled in the art without departing from the scope of the invention.

1. A dry-mateable subsea electrical connector coupling, the coupling comprising:
a removable connector body adapted to couple a first connector part, terminated to a subsea cable or jumper, to a subsea sensor device, or to a subsea wet mateable connector part wherein the removable connector body is adapted to seal a chamber of the first connector part terminated to the subsea hose or jumper and is adapted to receive electrical conductors of the subsea sensor device, or of the subsea wet-mateable connector part; and
wherein the removable connector body comprises electrical conductors and fittings adapted to receive corresponding electrical conductors and fittings from the hose or jumper.

2. The coupling according to claim 1,
wherein the electrical conductors and fittings of the removable connector body comprise female electrical conductors and fittings and the corresponding electrical conductors and fittings comprise cables from the hose or jumper.

3. The coupling according to claim 1,
wherein the electrical conductors and fittings of the removable connector body comprise one or more inductively couplable electrical conductors and the corresponding electrical conductors and fittings comprise one or more inductively couplable electrical conductors from the hose or jumper.

4. A termination for a subsea cable or jumper, the termination comprising:
a first connector part; and
a dry-mateable subsea electrical connector coupling according to claim 1;
wherein the first connector part comprises: a housing; seals to seal the coupling to the housing; and a release mechanism to releasably hold the removable connector body in place in the housing.

5. A subsea connector for a subsea cable or jumper, the subsea connector comprising:
a termination according to claim 4 and a second connector part;
wherein the second connector part comprises a housing; a connector body sealed to the housing; and electrical conductors; and
wherein the electrical conductors of the second connector part are adapted to electrically connect with the electrical conductors of the first connector part.

6. The subsea connector according to claim 5,
wherein the electrical conductors of the second connector part comprise male conductor pins and the electrical conductors of the first connector part comprise female electrical conductors corresponding to the male conductor pins.

7. The subsea connector according to claim 5,
wherein the female electrical conductors comprise conductors of the removable connector body; and
wherein the second connector part comprises a wet-mate connector part.

8. A subsea connector for a subsea cable or jumper, the connector comprising:
a termination according to claim 4 and a second connector part;
wherein the second connector part comprises: a housing; a connector body sealed to the housing; and electrical conductors; and
wherein the electrical conductors of one of the first and second connector part comprise inductively couplable conductors.

9. The subsea connector according to claim 5,
wherein the seals comprise O-ring seals.

10. The subsea connector according to claim 5,
wherein the release mechanism comprises a circlip.

11. The subsea connector according to claim 5,
wherein the chamber further comprises a fluid inlet and closure member.

12. The coupling according to claim 2,
wherein the fittings further comprise boot seals to seal the cable conductors from fluid in the chamber.

13. The coupling according to claim 12,
wherein the fluid comprises oil.

14. The subsea connector according to claim 8,
wherein the first connector part comprises a first subsea housing portion including a first inductive coupling part; adapted to receive a second inductive coupling part of a subsea hose or jumper.

15. A connector for a subsea cable or jumper, the connector comprising:
a housing; the housing forming a chamber;
a first removable connector body within the housing,
the first removable connector body being adapted to couple a first connector part, terminated to a subsea cable or jumper, to a subsea sensor device, or to a subsea wet mateable connector part,
the first removable connector body being sealingly engaged with one end of the chamber and a cable termination sealingly engaged with the other end of the chamber.

16. A coupling according to claim 1,
wherein the fittings comprise swage or crimp fittings.

17. A method of assembling a subsea connector part, the method comprising:
feeding conductors of a subsea hose, cable or jumper into a housing,
terminating the conductors to terminations of a removable connector body of the housing;
sealing the removable connector body to the housing at one end of a chamber in the housing;
sealing the hose, cable or jumper to the housing at the other end of the chamber; and
filling the chamber with a pressure balancing fluid through a fluid inlet and closing the fluid inlet.

18. The method according to claim 17,
wherein the chamber is filled through a fluid inlet at an end of the hose, cable or jumper remote from the chamber.

19. The method according to claim 17,
wherein the chamber is filled through a fluid inlet in the chamber and after filling and allowing trapped air to escape, the fluid inlet is closed.

20. The method according to claim 17,
wherein the subsea connector comprises a plug connector part and a receptacle connector part;
wherein the method further comprises:
removing the removable connector body from the receptacle connector part; and
terminating the cables directly to termination fittings of the plug connector part.

21. The method according to claim 17,
wherein the method further comprises:
deploying the connector part subsea and electrically connecting a subsea device to the connector part with a wet-mateable connector part comprising male conductor pins corresponding to female conductor pins in the removable connector body of the connector part, by bringing the connector parts and their conductors into contact.

22. The method according to claim 17,
wherein the method further comprises:
disconnecting the cables from the termination fittings of the removable connector body of the housing,
removing the removable connector body,
connecting the cables to male conductor pins of a dry mateable plug connector part inserted into the receptacle housing and
sealing the plug and receptacle parts.

23. The termination according to claim 4, wherein the seals comprise O-ring seals.

24. The termination according to claim 4, wherein the release mechanism comprises a circlip.

25. The termination according to claim 4, wherein the chamber further comprises a fluid inlet and closure member.

26. The coupling according to claim 1, wherein the chamber further comprises a fluid inlet and closure member.

27. The coupling according to claim 13, wherein the oil comprises silicon oil.
